(19) United States
(12) Patent Application Publication
(10) Pub. No.: US 2021/0166278 A1
(43) Pub. Date: Jun. 3, 2021

(54) METHODS AND APPARATUS FOR ELECTRONICALLY PROVIDING DIVERSIFIED ITEM ADVERTISEMENT RECOMMENDATIONS

(71) Applicant: Walmart Apollo, LLC, Bentonville, AR (US)

(72) Inventors: Habibur RAHMAN, San Jose, CA (US); Zeinab TAGHAVI NASR ABADI, Oakland, CA (US)

(21) Appl. No.: 16/701,439

(22) Filed: Dec. 3, 2019

(51) Int. Cl. G06Q 30/02

(52) U.S. Cl. CPC G06Q 30/0277; G06Q 30/0253

(57) ABSTRACT

This application relates to apparatus and methods for automatically diversifying item advertisements, such as advertisements for items displayed on a website. In some examples, a computing device receives a plurality of recommended items to advertise with an anchor item. The computing device may determine a relevancy between each of the plurality of recommended items and the anchor item. The computing device may also determine a distance between each of the plurality of recommended items. The distances may be determined based on, for example, a category of each item. The computing device may then execute a diversity determination model based on the relevancies and distances to determine a diversified subset of the recommended items. Advertisements for the diversified subset of recommended items may then be displayed, such as on a webpage dedicated to the anchor item.

### TECHNICAL FIELD

The disclosure relates generally to digital advertisements and, more specifically, to electronically determining and providing item advertisement recommendations.

### BACKGROUND

At least some websites, such as retailer websites, display item advertisements. The item advertisements may include an image of an item, and a price of the item. For example, a website may display item advertisements, and may further allow a customer to purchase the advertised items. The displayed advertisements may be determined by advertisement recommendation systems, which attempt to provide advertisements for items which customers may be interested in. At least some recommendation systems provide cross-sell recommendations, where advertisements are displayed in relation to an anchor item. In some examples, however, the advertisement recommendation systems provide advertisements for items that are irrelevant to the customer, or for items the customer is not interested in. For example, the recommendation systems may provide cross-sell recommendations for items that are similar to each other, such as of the same type.

As a result, a retailer may lose sales of items to a customer. For example, the customer may not buy an advertised item. In addition, the customer may leave the website without having purchased an item that, if shown an advertisement for, the customer would have purchased. In some examples, if a customer perceives an advertisement as irrelevant, the customer may go elsewhere, such as another website, to make another purchase. As such, there are opportunities to address advertisement recommendation systems.

### SUMMARY

The embodiments described herein are directed to automatically determining and providing digital item advertisements that may be displayed, for example, on a website. The embodiments may allow a person, such as a customer, to be presented with advertisements that may be more relevant to (e.g., likely to interest) the person. For example, the embodiments may allow the person to view advertisements that are more diversified, such as items that the person may be more interested in purchasing. As such, the embodiments may allow for an improved user experience with purchasing items on a website. In addition, because a person may now spend less time reviewing irrelevant advertisements, the person may have additional time to consider additional items for purchase. Moreover, the embodiments may allow a retailer to increase item advertisement conversions (e.g., an amount of advertised items sold). In addition to or instead of these example advantages, persons of ordinary skill in the art having the benefit of these disclosures may recognize and appreciate other advantages as well.

In accordance with various embodiments, exemplary systems may be implemented in any suitable hardware or hardware and software, such as in any suitable computing device. For example, in some embodiments, a computing device receives a plurality of recommended items to advertise with an anchor item. The computing device may determine a relevancy between each of the plurality of recommended items and the anchor item. The computing device may also determine a distance between each of the plurality of recommended items. The distances may be determined based on, for example, a category of each item. The computing device may then execute a diversity determination model based on the relevancies and distances to determine a diversified subset of the recommended items. Advertisements for the diversified subset of recommended items may then be displayed, such as on a webpage dedicated to the anchor item.

In some embodiments, a computing device is configured to receive, for an anchor item, a plurality of recommended items to advertise. The computing device may also be configured to determine a plurality of subsets, where each subset comprises at a portion of the plurality of recommended items. The computing device may further be configured to determine, for each subset of the plurality of subsets, a relevancy value between the anchor item and each of the recommended items of the subset. The computing device may also be configured to determine, for each subset of the plurality of subsets, a distance value between each of the recommended items of the subset. The computing device may further be configured to determine, for each subset of the plurality of subsets, a diversity value for the subset based on the relevancy value and the distance value corresponding to the subset. The computing device may be configured to determine a diversified subset of the plurality of subsets based on the diversity values for the plurality of subsets.

The computing device may, in some examples, be configured to transmit, to a second computing device, diversified item data identifying the recommended items corresponding to the diversified subset of the plurality of subsets. In some examples, the computing device may be configured to display advertisements for the recommended items corresponding to the diversified subset of the plurality of subsets.

In some embodiments, a method is provided that includes receiving, for an anchor item, a plurality of recommended items to advertise. The method may also include determining a plurality of subsets, wherein each subset comprises at a portion of the plurality of recommended items. The method may further include determining, for each subset of the plurality of subsets, a relevancy value between the anchor item and each of the recommended items of the subset. The method may include determining, for each subset of the plurality of subsets, a distance value between each of the recommended items of the subset. The method may also include determining, for each subset of the plurality of subsets, a diversity value for the subset based on the relevancy value and the distance value corresponding to the subset. Further, the method may include determining a diversified subset of the plurality of subsets based on the diversity values for the plurality of subsets.

In some examples, the method may include transmitting, to a second computing device, diversified item data identifying the recommended items corresponding to the diversified subset of the plurality of subsets. In some examples, the method may include displaying advertisements for the recommended items corresponding to the diversified subset of the plurality of subsets.

In yet other embodiments, a non-transitory computer readable medium has instructions stored thereon, where the instructions, when executed by at least one processor, cause a computing device to perform operations that include receiving, for an anchor item, a plurality of recommended items to advertise. The operations may also include determining a plurality of subsets, wherein each subset comprises at a portion of the plurality of recommended items. The operations may further include determining, for each subset of the plurality of subsets, a relevancy value between the anchor item and each of the recommended items of the subset. The operations may include determining, for each subset of the plurality of subsets, a distance value between each of the recommended items of the subset. The operations may also include determining, for each subset of the plurality of subsets, a diversity value for the subset based on the relevancy value and the distance value corresponding to the subset. Further, the operations may include determining a diversified subset of the plurality of subsets based on the diversity values for the plurality of subsets.

In some examples, the operations include transmitting, to a second computing device, diversified item data identifying the recommended items corresponding to the diversified subset of the plurality of subsets. In some examples, the operations may include displaying advertisements for the recommended items corresponding to the diversified subset of the plurality of subsets.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a digital advertisement diversification system in accordance with some embodiments;

FIG. 2 is a block diagram of the advertisement diversification computing device of the digital advertisement diversification system of FIG. 1 in accordance with some embodiments;

FIG. 3 is a block diagram illustrating examples of various portions of the digital advertisement diversification system of FIG. 1 in accordance with some embodiments;

FIGS. 4A and 4B illustrate distances between recommended items associated with an anchor item in accordance with some embodiments;

FIG. 5 illustrates exemplary portions of the advertisement diversification computing device of FIG. 2 in accordance with some embodiments;

FIG. 6 is a flowchart of an example method that can be carried out by the advertisement diversification computing device of FIG. 2 in accordance with some embodiments; and

FIG. 7 is a flowchart of another example method that can be carried out by the advertisement diversification computing device of FIG. 2 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

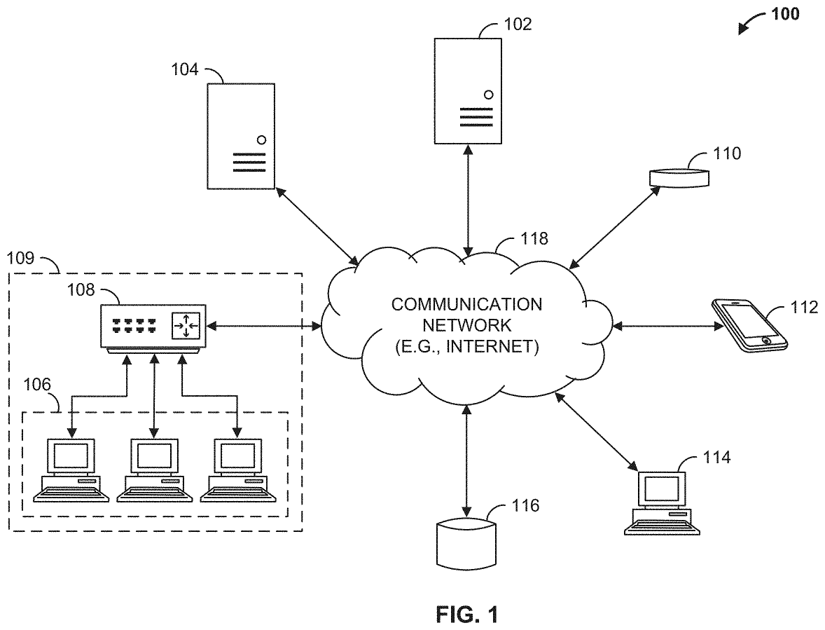

Turning to the drawings, FIG. 1 illustrates a block diagram of a digital advertisement diversification system 100 that includes an advertisement diversification computing device 102 (e.g., a server, such as an application server), a web server 104, workstation(s) 106, database 116, and multiple customer computing devices 110, 112, 114 operatively coupled over network 118. Advertisement diversification computing device 102, workstation(s) 106, server 104, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, advertisement diversification computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, advertisement diversification computing device 102 is operated by a retailer, and multiple customer computing devices 112, 114 are operated by customers of the retailer.

Although FIG. 1 illustrates three customer computing devices 110, 112, 114, digital advertisement diversification system 100 can include any number of customer computing devices 110, 112, 114. Similarly, digital advertisement diversification system 100 can include any number of workstation(s) 106, advertisement diversification computing devices 102, servers 104, and databases 116.

Workstation(s) 106 are operably coupled to communication network 118 via router (or switch) 108. Workstation(s) 106 and/or router 108 may be located at a store 109, for example. Workstation(s) 106 can communicate with advertisement diversification computing device 102 over communication network 118. The workstation(s) 106 may send data to, and receive data from, advertisement diversification computing device 102. For example, the workstation(s) 106 may transmit data related to an order purchased by a customer at store 109 to advertisement diversification computing device 102. In response, advertisement diversification computing device 102 may transmit an indication of one or more item advertisements to provide to the purchasing customer. For example, the item advertisements may be displayed on a receipt handed to the customer for the purchase order.

In some examples, web server 104 may host one or more web pages, such as a retailer's website. The website may allow a customer to view and purchase items. For example, the website may display advertisements for items that a customer may purchase on the website. In some examples, advertisement diversification computing device 102 may transmit one or more item advertisements to display on the website. For example, the item advertisements may be displayed on a checkout webpage, on a homepage, on an item webpage, or on a webpage dedicated to a category of the advertised item, such as when a customer is browsing that webpage.

In some examples, web server 104 transmits user transaction data to advertisement diversification computing device 102. User transaction data may identify, for example, purchase transactions (e.g., the purchase of items) on a website.

In some examples, web server 104 transmits user session data to advertisement diversification computing device 102. User session data may identify items viewed, engaged (e.g., clicked on), or purchased on a website. User session data may also identify, for example, item advertisement impressions, items added to an online shopping cart, or items purchased after an engagement on the website of an advertisement for the items. User session data may also identify any other data related to the browsing of a website.

First customer computing device 110, second customer computing device 112, and N^{th} customer computing device 114 may communicate with web server 104 over communication network 118. For example, each of multiple computing devices 110, 112, 114 may be operable to view, access, and interact with webpages of a website hosted by web server 104. In some examples, web server 104 hosts a website for a retailer that allows for the purchase of items. An operator of one of multiple computing devices 110, 112, 114 may access the website hosted by web server 104, add one or more items to an online shopping cart of the website, and perform an online checkout of the shopping cart to purchase the items.

Advertisement diversification computing device 102 is operable to communicate with database 116 over communication network 118. For example, advertisement diversification computing device 102 can store data to, and read data from, database 116. Database 116 can be a remote storage device, such as a cloud-based server, a memory device on another application server, a networked computer, or any other suitable remote storage. Although shown remote to advertisement diversification computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Advertisement diversification computing device 102 can diversify items recommended to be advertised based on an anchor item. For example, for each anchor item, a corresponding plurality of recommended items (e.g., suggested items for purchase) to advertise may be received. The items may be advertised by displaying them on a webpage associated with an anchor item. The webpage may be hosted by web server 104, for example. To diversify the item advertisement recommendations, advertisement diversification computing device 102 may execute a relevance determination model to determine a relevance value (e.g., score) for each recommended item and anchor item pair.

For example, the relevance determination model may determine relevance values based on pre-determined conversion probabilities, such as cross-sell scores, for each recommended item (e.g., a computed probability that a customer will click on or purchase the recommended item if displayed as a suggested item to the anchor item). In some examples, the relevance determination model is based on category affinity scores. For example, the relevance determination model may generate a relevance value based on a similarity between a word embedding representing a category of the anchor item and a word embedding representing a category of the recommended item. In some examples, the embeddings are calculated from categorical co-count values (e.g., matrices). Categorical co-counts for, as an example, two item categories x and y, may be defined as the number of times (e.g., over a period of time such as 30 days, a month, a year, etc.) items from category x and from category y are purchased together in a same transaction. In some examples, the categorical co-counts may include the number of times (e.g., over a period of time) items from the categories are added to the same online shopping cart during a same user session. The relevance determination model may be based on other metrics as well. For example, relevancies may be determined using Pointwise Mutual Information (PMI) between the anchor item and a recommended item. In some examples, PMI can be calculated according to

$$PMI ( x , y ) = log \frac{p ( x , y )}{p ( x ) p ( y )} ,$$

where p(x,y) can be calculated as the co-purchase between two product x and y.

Advertisement diversification computing device 102 may also execute a distance determination model to determine distance values between at least a subset of the recommended items for the anchor item. In some examples, the distance determination model determines distance values based on similarities between features of the recommended items. For example, the feature may be a primary shelf of each of the recommended items. The primary shelf of each item may be based on a taxonomical hierarchy that defines which category a product belongs to. For example, a primary shelf for brand “A” laptops may be: Electronics/Computers/Laptops/Brand A Laptops. In other examples, the feature may be a product type, a division, a category, a subcategory, or any other feature of the recommended items.

Based on the features of the recommended items, a distance may be computed. For example, the distance may be computed based on the Jaccard coefficient. In some examples, because the Jaccard coefficient increases the more that two features are similar (e.g., the Jaccard coefficient increases as the union of two feature sets increases), the inverse of the Jaccard coefficient (i.e., the Jaccard distance) is computed. For example, the Jaccard distance may be computed according to Jaccard Distance(x,y)=1.0−Jaccard coefficient (x,y). As an example, a value of 1 may represent most different features, and a value of 0 may represent most similar features. As such, recommended items that are more similar to each other receive a lesser value than recommended items that are less similar to each other, respectively. In some examples, the distance may be computed according to a Eucledian Distance (X,Y) or Cosine Distance(X,Y), where X and Y are feature vectors representing item x (e.g., a first recommended item of a subset) and item y (e.g., a second recommended item of the subset).

Advertisement diversification computing device 102 may further execute a diversity determination model to determine diversity values (e.g., diversity scores) for one or more subsets of the recommended items based on the relevance values and the distance values. In some examples, the diversity determination model, for each subset of a plurality of subsets of the recommended items, determines the minimum distance value (e.g., based on the distance determination model) between a first recommended item and a plurality of additional recommended items. The diversity determination model also determines, for each of the first recommended item and the plurality of additional recommended items, a minimum relevance value (e.g., based on the relevance determination model). The diversity determination model then determines a subset of the plurality of subsets of the recommended item based on the minimum distance value and the minimum relevance value. For example, the diversity determination model may generate diversity values based on the following equation (e.g., maximum-minimum equation), where the equation may be executed based on one or more subsets of the recommended items:

$${Arg max}_{S} \{ f ( S ) = {min}_{\{ a ∈ S ]} w ( a ) + λ {min}_{\{ ( b , c ) ∈ E \}} d ( b , c ) \} \qquad ( eq . 1 )$$

where:
   S represents a subset of recommended items;
   E represents an edge set of S (e.g., edges between the recommended items of subset S);
   w(a) represents the relevance for recommended item a of subset S to an anchor item;
   d(b, c) represents the distance between recommended items b and c of subset S; and
   λ represents a diversity coefficient (e.g., 0 to 1, inclusive).

The above equation identifies a subset of recommended items with the maximum diversity value f(S), where E represents the edge set of a subset S of recommended items. If, for example, S={a,b,c}, then E={(a,b), (b,c), (a,c)}. Here, the

$${min}_{\{ a ∈ S ]} w ( a )$$

term identifies the minimum relevancy value of all of the recommended items of subset S, where the term

$${min}_{\{ ( b , c ) ∈ E \}} d ( b , c ) \}$$

identifies the minimum distance between any of the recommended items of subset S.

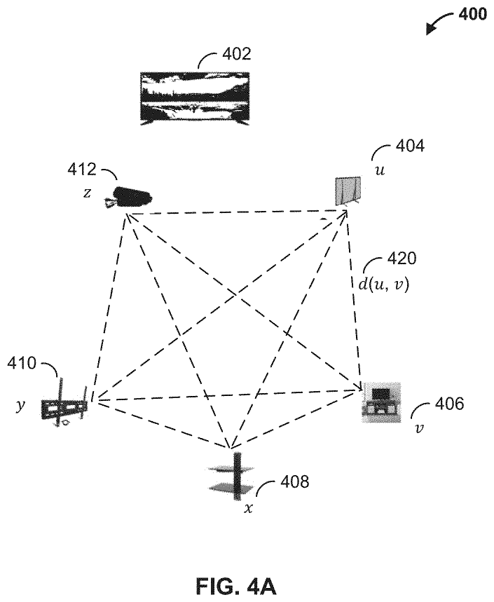

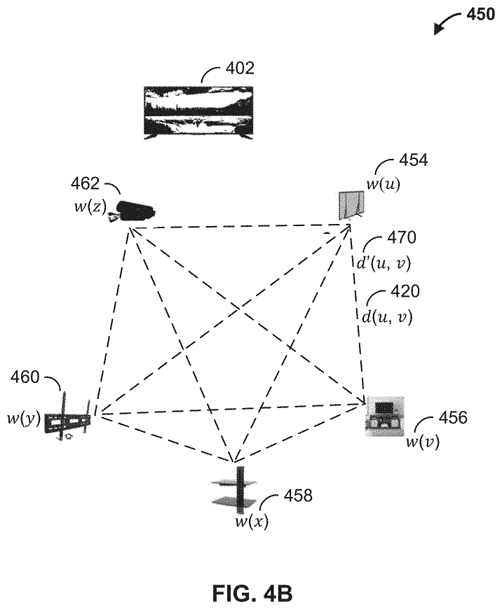

FIG. 4A illustrates a graph 400 for an anchor item 402 (e.g., a television). Graph 400 also includes recommended items u 404, v 406, x 408, y 410, and z 412, as well as edges, indicated by dashed lines, between each of the recommended items. As an example, and with reference to equation 1, one subset S may include recommended items u 404, v 406, and z 412 ({u, v, z}), and edge set E may include an edge between u 404 and v 406, an edge between v 406 and z 412, and an edge between u 404 and z 412 (i.e., edge set {(u,v), (v,z), (u,z)}). Each edge can represent a distance between the recommended items. For example, the edge between recommended items u 404 and v 406 represents distance d(u, v) 420. The distances associated with each of the edges may be computed based on the distance determination model.

Referring back to equation 1 above, the diversity determination model may be provided with a number of the recommended items to be diversified (represented as variable k below). For example, an operator of advertisement diversification computing device 102 may provide the number of recommended items to be diversified, or the number may be received from another computing device. Assume, for this example, that the number of recommended items to be diversified is three (out of the five recommended items u 404, v 406, x 408, y 410, and z 412). Advertisement diversification computing device 102 may execute the diversity determination model, which in this example is based on equation 1 above, based one or more subsets of three recommended items. For example, a first subset may include recommended items u 404, v 406, and z 412. A second subset may include recommended items u 404, x 408, and z 412. A third subset may include recommended items u 404, z 412, and y 410. A fourth subset may include recommended items x 408, z 412, and y 410, and a fifth subset may include v 406, x 408, and z 412.

In some examples, the diversity determination model determines the maximum diversity value f(S) of a plurality of subsets (e.g., a total number of differing subsets that can be made with the available recommended items). The subset with the maximum diversity value f(S) is then selected. For example, and with reference to FIG. 4A, one subset may include recommended items u 404, v 406, and z 412, a second subset may include recommended items u 404, x 408, and z 412, and a third subset may include recommended items u 404, z 412, and y 410. For each subset, advertisement diversification computing device 102 may execute the diversity determination model to determine the subset with the maximum diversity value f(S).

In some examples, a distance value between recommended items may be determined based on relevancy values. For example, FIG. 4B illustrates a graph 450 for the same anchor item 402 (e.g., a television). Graph 450 also includes relevancy value w(u) 454 for recommended item u 404, relevancy value w(v) 456 for recommended item v 406, relevancy value w(x) 458 for recommended item x 408, relevancy value w(y) 460 for recommended item y 410, and relevancy value w(z) 462 for recommended item z 412. In graph 450, the distance between recommended items is adjusted based on the relevancy values of the recommended items. For example, the distance recommended items u 404 and v 406 is represented by adjusted distance d′(u, v) 470, which is based on d(u, v) 420. The distances associated with each of the edges may be computed based on relevancy value w(u) 454, relevancy value w(v) 456, and distance d(u, v) 420.

In some examples, adjusted distance values may be computed according to the equation below:

d′(a,b)=½(w(a)+w(b))+λd(a,b) (eq. 2)
where:
   w(a) is the relevancy value of recommended item a;
   w(b) is the relevancy of another recommended item b; and
   d(a, b) represents the distance between recommended items a and b.

Assuming adjusted distances are computed based on equation 2 above, equation 1 may be simplified. Specifically, the diversity values f(S) may be determined based on minimizing equation 2. For example, the diversity values f(S) may be computed according to the equation below:

$${Arg max}_{S} \{ f ( S ) = {min}_{\{ ( a , b ) ∈ E \}} {d}^{′} ( a , b ) \} \qquad ( eq . 3 )$$

In some examples, rather than computing the maximum diversity value f(S) for any subset of a set of recommended items S, the maximum diversity value is estimated based on determining the recommended items with a maximum distance (e.g., as represented by an edge), and distances from the recommended items with a maximum distance to the other recommended items. For example, assume a set S with recommended items u, v, w, x, and y, where edge set E represents any edge between any two recommended items of set S. First, the edge of edge set E with a maximum distance is first determined. For example, the distances between the edges may be determined based on equation 2 above. Assume that the edge between items u and v, represented by d′ (u, v), has the maximum distance of all edges of edge set E. Based on the edge with the maximum distance, a minimum distance between each recommended item that is part of the maximum distance edge (in this example, u and v) to every other edge of the set S (in this example, w, x, and y) is determined. For example, the distances may be determined according to equation 2 above. Out of the minimum distances, the recommended item associated with the maximum distance is selected (e.g., the recommended item for which the minimum distance is maximum). In this example, the maximum distance may be selected according to, for example, Argmax [min{d′(w,u), d′(w,v)}, min{d′(x,u), d′(x,v)}, min{d′(y,u), d′(y,v)}]. Here, either recommended item w, x, or y is going to be selected based on this equation. The set of diversified items would then include the recommended items that are part of the maximum distance edge (u and v in this example), and the recommended item associated with the maximum distance selected (either w, x, or y in this example).

In some examples, the diversity determination model may be based on the following equation (e.g., maximum-average equation), where the equation may be executed based on one or more subsets of the recommended items:

$${Arg max}_{S} \{ f ( S ) = ( k - 1 ) {\sum }_{\{ n ∈ S \}} w ( n ) + 2 λ {\sum }_{\{ ( n , s ) ∈ E \}} d ( n , s ) \} \qquad ( eq . 4 )$$

where:
   S represents the set of recommended items;
   E represents a subset of the set of recommended items;
   w(n) represents the relevance for recommended item n to an anchor item;
   d(n, s) represents the distance between recommended items n and another recommended item;
   λ represents a diversity coefficient (e.g., 0 to 1, inclusive); and
   k represents the number of recommended items to select (e.g., diversify).

For example, if five recommended items are received (e.g., set S), and three are to be selected, variable k is three. The number of possible edges of a set S with a number of recommended items item_num and a number of recommended items to be selected k may be determined according to the equation below.

number of edges of edge set E=item_num*(k−1)/2 (eq. 5)

If the maximum diversity values f(S) associated with any two or more subsets are the same, in some examples, advertisement diversification computing device 102 selects the subset for which the diversity values were first computed. In some examples, if the maximum diversity values f(S) associated with any two or more subsets are the same, advertisement diversification computing device 102 selects the subset with recommended items with a highest average relevance (e.g., as determined by the relevance determination engine) to the anchor item.

Based on the maximum diversity values f(S), a subset of recommended items is selected. The selected subset of recommended items represent diversified items. These diversified items may then be provided to determine advertisements to display in association with the corresponding anchor item. For example, the diversified items may be transmitted to web server 104. Web server 104 may then display advertisements for the diversified items. In some examples, the diversified items are advertised on a webpage of an anchor item (e.g., the anchor item being the “main” item displayed on the webpage). For example, advertisements for the diversified items may be displayed as suggested additional items to be purchased along with the anchor item. In some examples, advertisements for the diversified items may be displayed on a webpage illustrating that the anchor item has been added to an online shopping cart (e.g., checkout webpage).

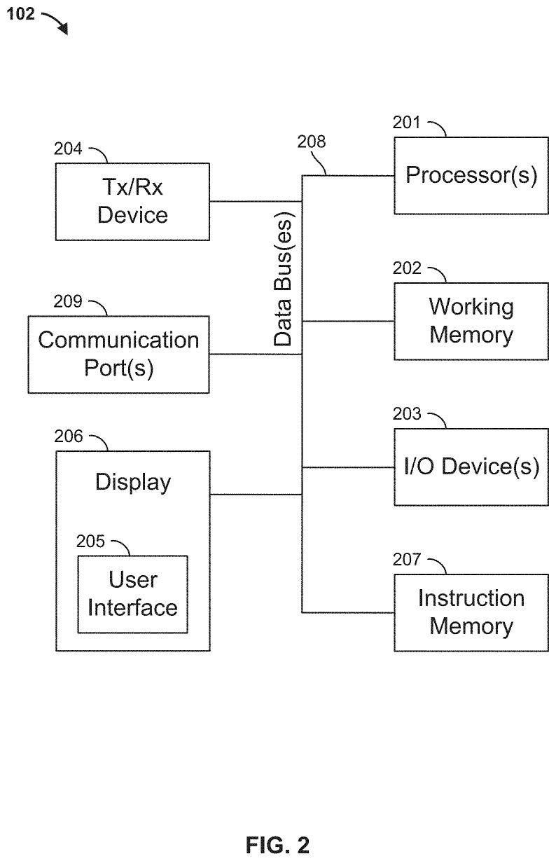

FIG. 2 illustrates the advertisement diversification computing device 102 of FIG. 1. Advertisement diversification computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of advertisement diversification computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning algorithm training data.

Display 206 can display user interface 205. User interfaces 205 can enable user interaction with advertisement diversification computing device 102. For example, user interface 205 can be a user interface for an application of a retailer that allows a customer to view and interact with a retailer's webpage. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 advertisement diversification computing device 102 will be operating in. Processor(s) 201 is operable to receive data from, or send data to, a network, such as communication network 118 of FIG. 1, via transceiver 204.

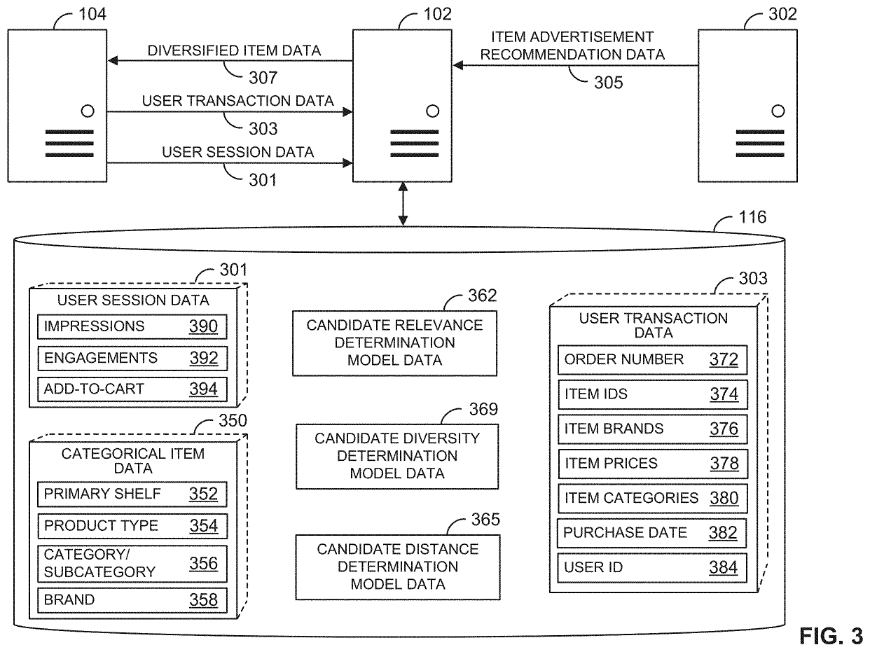

FIG. 3 is a block diagram illustrating examples of various portions of the digital advertisement diversification system 100 of FIG. 1. As indicated in the figure, advertisement diversification computing device 102 may receive user session data 301 and user transaction data 303 from web server 104. User session data 301 may identify data associated with browsing sessions of a plurality of users (e.g., customers). For example, user session data 301 may identify impressions 390 (e.g., item advertisements viewed), engagements 392 (e.g., item advertisements engaged), add-to-cart 394 (e.g., items added to online shopping carts), and any other data related to website browsing sessions. User transaction data 303 may identify any data related to the purchase of items, such as an order number 372, item identifications (IDs) 374, item brands 376, item prices 378, item categories 380, purchase dates 382, and user IDs 384 (e.g., the user ID of a customer making the purchase on the website). Advertisement diversification computing device 102 may store user session data 301 and user transaction data 303 in database 116.

In this example, database 116 also stores candidate relevance determination model data 362, candidate distance determination model data 365, and candidate diversity determination model data 369. Candidate relevance determination model data 362 identifies and characterizes a relevance determination model that, when executed, computes relevancy values, such as between an anchor item and a recommended item. Candidate distance determination model data 365 identifies and characterizes a determination model that, when executed, computes distance values between recommended items for an anchor item.

Candidate diversity determination model data 369 identifies and characterizes a diversity determination model that, when executed, computes diversity values (e.g., diversity scores) for recommended items based on relevance values (e.g., as determined by candidate relevance determination model data 362) and distance values (e.g., as determined by candidate distance determination model data 365). For example, candidate diversity determination model data 369 may compute diversity values f(S). Advertisement diversification computing device 102 may obtain (from database 116) and execute candidate relevance determination model data 362, candidate distance determination model data 365, and candidate diversity determination model data 369.

Advertisement diversification computing device 102 may also receive item advertisement recommendation data 305 from a recommendation system 302. Recommendation system 302 can be, for example, a server that generates recommendations for item to advertise. Recommendation system 302 may generate the recommendations based on the execution of one or more models, such as machine learning models, for example. Item advertisement recommendation data 305 identifies and characterizes recommendations of items to advertise with an anchor item. For example, item advertisement recommendation data 305 may identify a plurality of items that are to be advertised on a webpage of a corresponding anchor item.

Advertisement diversification computing device 102 may receive item advertisement recommendation data 305, and determine relevancies between the identified recommended items to the corresponding anchor item. For example, advertisement diversification computing device 102 may execute candidate relevance determination model data 362 to determine the relevancies (e.g., relevancy values).

Advertisement diversification computing device 102 may also determine distances between the recommended items. For example, advertisement diversification computing device 102 may execute candidate distance determination model data 365 to determine the distances (e.g., distance values).

Based on the determined relevancies and distances, advertisement diversification computing device 102 may generate diversified item data 307 identifying a subset of the recommended items for the corresponding anchor item. For example, based on the determined relevancies and distances of the recommended items, advertisement diversification computing device 102 may execute candidate diversity determination model data 369 to generate diversified item data 307 identifying a subset of the recommended items. Advertisement diversification computing device 102 may transmit diversified item data 307 to another computing device, such as web server 104. Web server 104 may advertise the identified subset of the recommended items in association with the corresponding anchor item (e.g., on a webpage of the anchor item, as a cross-sell item, etc.).

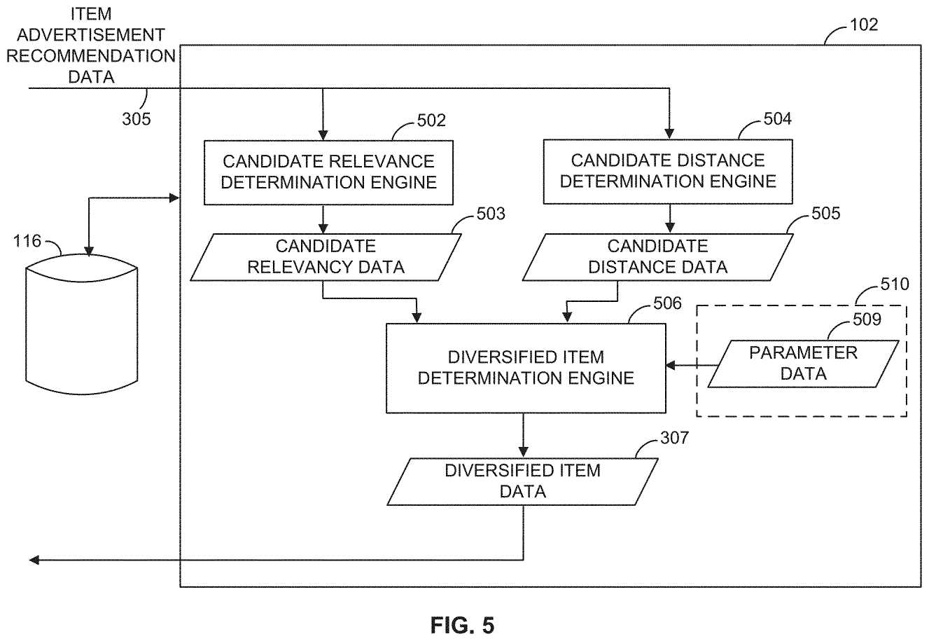

FIG. 5 illustrates various portions of the digital advertisement diversification system 100 of FIG. 1. As illustrated in the figure, advertisement diversification computing device 102 includes candidate relevance determination engine 502, candidate distance determination engine 504, and diversified item determination engine 506. In some examples, one or more of candidate relevance determination engine 502, candidate distance determination engine 504, and diversified item determination engine 506 may be implemented in hardware. In some examples, one or more of candidate relevance determination engine 502, candidate distance determination engine 504, and diversified item determination engine 506 may be implemented may be implemented as an executable program maintained in a tangible, non-transitory memory, such as instruction memory 207 of FIG. 2, which may be executed by one or processors, such as processor 201 of FIG. 2.

Candidate relevance determination engine 502 may receive item advertisement recommendation data 305, and may generate candidate relevancy data 503 based on the recommended items to the corresponding anchor item identified by item advertisement recommendation data 305. For example, candidate relevance determination engine 502 may execute a candidate relevance determination model, such as one identified by candidate relevance determination model data 362, to compute relevancy values between each recommended item to the anchor item.

Candidate distance determination engine 504 may receive item advertisement recommendation data 305, and may generate candidate distance data 505 between the recommended items identified by item advertisement recommendation data 305. For example, candidate distance determination engine 504 may execute a candidate distance determination model, such as one identified by candidate distance determination model data 365, to compute distance values between recommended items.

Diversified item determination engine 506 may receive candidate relevancy data 503 from candidate relevance determination engine 502, and candidate distance data 505 from candidate distance determination engine 504. Diversified item determination engine 506 may generate diversified item data 307 identifying a subset of recommended items based on candidate relevancy data 503 and candidate distance data 505. For example, diversified item determination engine 506 may execute a candidate diversity determination model, such as one identified by candidate diversity determination model data 369, to identify the subset of recommended items.

In some examples, the candidate diversity determination model may be based, in some examples, on one of equations 1, 3, or 4 as described above. For example, diversified item determination engine 506 may determine subsets of the recommended items, where each subset of recommended items includes a specified number of recommended items to diversify (e.g., parameter k described above with respect to equation 4). For each subset, diversified item determination engine 506 may compute diversity values f(S). Diversified item determination engine 506 may then identify the subset of recommended items with the maximum diversity value f(S).

In some examples, diversified item determination engine 506 obtains parameter data 509 from, for example, a memory 510, to execute a candidate diversity determination model. Parameter data 509 identifies parameters that may be required by the candidate diversity determination model. For example, parameter data 509 may identify parameter), which represents a diversity coefficient, and parameter k, which represents the number of recommended items to select (e.g., diversify), such as for a candidate diversity determination model based on equation 4 described above.

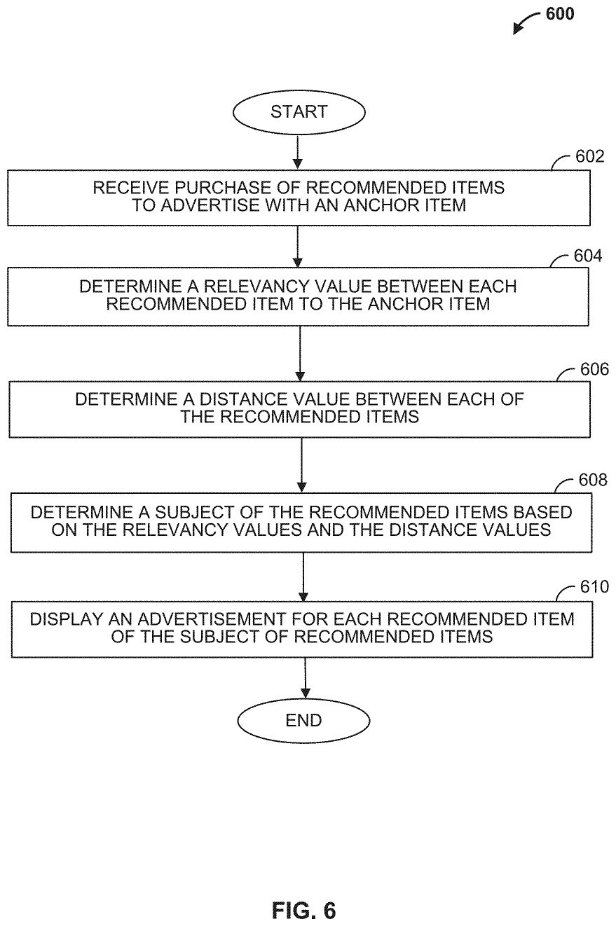

FIG. 6 is a flowchart of an example 600 that can be carried out by the digital advertisement diversification system 100 of FIG. 1. Beginning at step 602, a plurality of recommended items to advertise with an anchor item is received. The anchor item may be a main item advertised on a webpage, and the plurality of recommended items may be items that may be advertised on the webpage for the anchor item. At step 604, a relevancy value between each recommended item to the anchor item is determined. For example, digital advertisement diversification computing device 102 may execute a relevance determination model, such as one identified by candidate relevance determination model data 362, to determine each relevancy value. At step 606, a distance value is determined between each of the recommended items. For example, digital advertisement diversification computing device 102 may execute a distance determination model, such as one identified by candidate distance determination model data 365, to determine each distance value.

Proceeding to step 608, a subset of recommended items is determined based on the relevancy values and the distance values. The subset of recommended items includes at least some of the plurality of recommended items that were received in step 602. For example, digital advertisement diversification computing device 102 may execute a diversity determination model, such as one identified by candidate diversity determination model data 369, to generate diversity values. The determined subset of recommended items may be a subset of a plurality of subsets with the maximum diversity value, for example. At step 610, an advertisement for each recommended item of the subset of recommended items is displayed. For example, web server 104 may display, on a webpage of the anchor item, an advertisement (e.g., image, link to recommended item page, link to purchase recommended item, etc.) for the subset of recommended items. The method then ends.

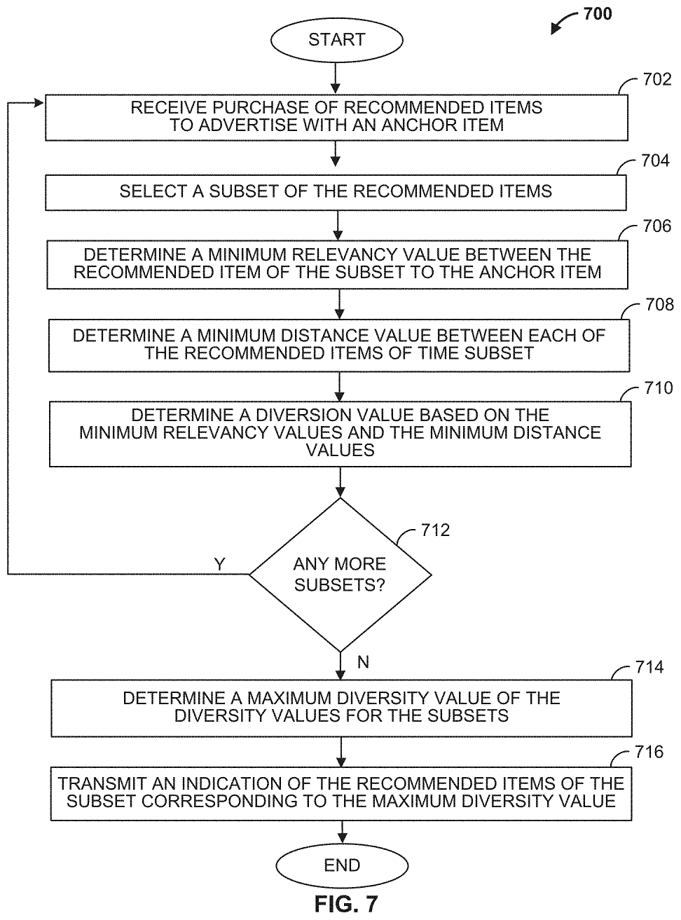

FIG. 7 is a flowchart of an example method 700 that can be carried out by the digital advertisement diversification system 400 of FIG. 4. At step 702, a plurality of recommended items to advertise with an anchor item is received. The anchor item may be a main item advertised on a webpage, and the plurality of recommended items may be items that may be advertised on the webpage for the anchor item. At step 704, a subset of the recommended items is selected. The subset may include a predetermined number of recommended items. For example, digital advertisement diversification computing device 102 may select three of five recommended items. At step 706, a minimum relevance value between the recommended items of the subset to the anchor item is determined. For example, digital advertisement diversification computing device 102 may execute a relevance determination model, such as one identified by candidate relevance determination model data 362, to determine a relevancy value between each of the recommended items of the subset to the anchor item. Digital advertisement diversification computing device 102 may then determine the minimum relevance value from the determined relevancy values for the subset.

At step 708, a minimum distance value between each of the recommended items of the subset is determined. For example, digital advertisement diversification computing device 102 may execute a distance determination model, such as one identified by candidate distance determination model data 365, to determine a distance value between each of the recommended items of the subset. Digital advertisement diversification computing device 102 may then determine the minimum distance value from the determined distance values for the subset.

Proceeding to step 710, a diversity value for the subset is determined based on the minimum relevancy value and the minimum distance value. For example, digital advertisement diversification computing device 102 may execute a diversity determination model, such as one identified by candidate diversity determination model data 369, to determine a diversity value for the subset based on the minimum relevancy value and the minimum distance value.

At step 712, a determination is made as to whether there are any more subsets. For example, digital advertisement diversification computing device 102 may determine whether there are any more differing combinations of a predetermined number of recommended items (e.g., a different combination of three recommended items) that can be made to form a subset. If there are any more subsets, the method proceeds back to step 704, where another subset is selected. Otherwise, if there are no more subsets, the method proceeds to step 714.

At step 714, a maximum diversity value of the diversity values for the subsets determined at step 710 is determined. For example, assuming there are five subsets of recommended items, digital advertisement diversification computing device 102 may compare the diversity values corresponding to each of the five subsets to each other to determine the highest maximum diversity value. The method then proceeds to step 716, where an indication of the recommended items associated with the subset with the maximum diversity value is transmitted. For example, the indication may be transmitted to a web server, such as web server 104. In response, the web server may display advertisements for the indicated recommended items on a webpage associated with the anchor item. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

1. A system comprising:
a database; and
a computing device communicatively coupled to the database and configured to:
receive, for an anchor item, a plurality of recommended items to advertise;
determine a plurality of subsets, wherein each subset comprises at a portion of the plurality of recommended items;
determine, for each subset of the plurality of subsets, a relevancy value between the anchor item and each of the plurality of recommended items of the subset;
determine, for each subset of the plurality of subsets, a distance value between each of the plurality of recommended items of the subset;
determine, for each subset of the plurality of subsets, a diversity value based on the relevancy value and the distance value corresponding to the subset;
determine a diversified subset of the plurality of subsets based on the diversity values for the plurality of subsets;
generate diversified item data identifying the recommended items corresponding to the diversified subset of the plurality of subsets;
store the diversified item data in the database; and
transmit, to a second computing device, the diversified item data.

2. The system of claim 1, wherein determining the relevancy value between the anchor item and each of the plurality of recommended items of the subset comprises executing a relevancy model to generate the relevancy value.

3. The system of claim 1, wherein determining the distance value between each of the plurality of recommended items of the subset comprises executing a distance model to generate the distance value.

4. The system of claim 3, wherein executing the distance model comprises determining a Jaccard distance of a category of each of the plurality of recommended items.

5. The system of claim 1, wherein determining the diversity value for the subset based on the relevancy value and the distance value corresponding to the subset comprises:
determining a minimum relevancy value of the relevancy values between the anchor item and each of the plurality of recommended items of the subset;
determining a minimum distance value of the distance values between each of the plurality of recommended items of the subset; and
determining the diversity value for the subset based on the minimum relevancy value and the minimum distance value.

6. The system of claim 1, wherein determining the diversity value for the subset based on the relevancy value and the distance value corresponding to the subset comprises executing a diversity determination model based on:
$${Arg max}_{S} \{ f ( S ) = {min}_{\{ a ∈ S ]} w ( a ) + λ {min}_{\{ ( b , c ) ∈ E \}} d ( b , c ) \} .$$

7. The system of claim 1, wherein determining the diversity value for the subset based on the relevancy value and the distance value corresponding to the subset comprises executing a diversity determination model based on:
$${Arg max}_{S} \{ f ( S ) = ( k - 1 ) {\sum }_{\{ a ∈ S \}} w ( a ) + 2 λ {\sum }_{\{ ( b , c ) ∈ E \}} d ( b , c ) \} .$$

8. The system of claim 1, wherein:
determining the distance value between each of the plurality of recommended items of the subset comprises executing a distance model based on d′(a,b)=½ (w(a)+w(b))+λd(a,b); and
determining the diversity value for the subset based on the relevancy value and the distance value corresponding to the subset comprises executing a diversity determination model based on
$${Arg max}_{S} \{ f ( S ) = {min}_{\{ ( a , b ) ∈ E \}} {d}^{′} ( a , b ) \} .$$

9. The system of claim 1, wherein the second computing device is configured to display on a webpage at least one advertisement for at least one of the plurality of recommended items identified in the diversified item data.

10. The system of claim 9, wherein the webpage is for the anchor item.

11. A method comprising:
receiving, for an anchor item, a plurality of recommended items to advertise;
determining a plurality of subsets, wherein each subset comprises at a portion of the plurality of recommended items;
determining, for each subset of the plurality of subsets, a relevancy value between the anchor item and each of the plurality of recommended items of the subset;
determining, for each subset of the plurality of subsets, a distance value between each of the plurality of recommended items of the subset;
determining, for each subset of the plurality of subsets, a diversity value based on the relevancy value and the distance value corresponding to the subset;
determining a diversified subset of the plurality of subsets based on the diversity values for the plurality of subsets;
generating diversified item data identifying the recommended items corresponding to the diversified subset of the plurality of subsets;
storing the diversified item data in a database; and
transmitting, to a second computing device, the diversified item data.

12. The method of claim 11 wherein determining the relevancy value between the anchor item and each of the plurality of recommended items of the subset comprises executing a relevancy model to generate the relevancy value.

13. The method of claim 11 wherein determining the distance value between each of the plurality of recommended items of the subset comprises executing a distance model to generate the distance value.

14. The method of claim 13 wherein executing the distance model comprises determining a Jaccard distance of a category of each of the plurality of recommended items.

15. The method of claim 11 wherein determining the diversity value for the subset based on the relevancy value and the distance value corresponding to the subset comprises:
determining a minimum relevancy value of the relevancy values between the anchor item and each of the plurality of recommended items of the subset;
determining a minimum distance value of the distance values between each of the plurality of recommended items of the subset; and
determining the diversity value for the subset based on the minimum relevancy value and the minimum distance value.

16. A non-transitory computer readable medium having instructions stored thereon, wherein the instructions, when executed by at least one processor, cause a device to perform operations comprising:
receiving, for an anchor item, a plurality of recommended items to advertise;
determining a plurality of subsets, wherein each subset comprises at a portion of the plurality of recommended items;
determining, for each subset of the plurality of subsets, a relevancy value between the anchor item and each of the plurality of recommended items of the subset;
determining, for each subset of the plurality of subsets, a distance value between each of the plurality of recommended items of the subset;
determining, for each subset of the plurality of subsets, a diversity value based on the relevancy value and the distance value corresponding to the subset;
determining a diversified subset of the plurality of subsets based on the diversity values for the plurality of subsets;
generating diversified item data identifying the recommended items corresponding to the diversified subset of the plurality of subsets;
storing the diversified item data in a database; and
transmitting, to a second computing device, the diversified item data.

17. The non-transitory computer readable medium of claim 16 wherein determining the relevancy value between the anchor item and each of the plurality of recommended items of the subset comprises executing a relevancy model to generate the relevancy value.

18. The non-transitory computer readable medium of claim 16 wherein determining the distance value between each of the plurality of recommended items of the subset comprises executing a distance model to generate the distance value.

19. The non-transitory computer readable medium of claim 18 wherein executing the distance model comprises determining a Jaccard distance of a category of each of the plurality of recommended items.

20. The non-transitory computer readable medium of claim 17 wherein determining the diversity value for the subset based on the relevancy value and the distance value corresponding to the subset comprises:
determining a minimum relevancy value of the relevancy values between the anchor item and each of the plurality of recommended items of the subset;
determining a minimum distance value of the distance values between each of the plurality of recommended items of the subset; and
determining the diversity value for the subset based on the minimum relevancy value and the minimum distance value.
